(19) United States
(12) Patent Application Publication
(10) Pub. No.: US 2018/0086132 A1
(43) Pub. Date: Mar. 29, 2018

(54) Storage Organizer

(71) Applicant: Robert Moore, McNeal, AZ (US)

(72) Inventor: Robert Moore, McNeal, AZ (US)

(21) Appl. No.: 15/276,337

(22) Filed: Sep. 26, 2016

(51) Int. Cl. B42F 13/40; A61J 1/03; B42F 13/00; B42F 13/22; G06F 19/00

(52) U.S. Cl. CPC B42F 13/40; A61J 1/03; B42F 13/0026; B42P 2241/02; G06F 19/3462; B42P 2241/16; B42F 13/22

(57) ABSTRACT

A storage organizer comprising a planar base sheet whereupon compartments or containers for storing items or substances may be arranged as a plurality of rows and columns, and where said organizer may be incorporated into a loose-leaf ringed binder simultaneously used to store and organize relevant paper documents. Categorization of stored items occurs through labeling space above columns and beside rows, while a paper or pull-out component situated beneath stored items allows for a submatrix stratification and characterization of stored contents. A method for efficiently storing and familiarizing medicines is addressed, comprising organization by day and a specific time or frequency of administration on the base sheet, with further characterization on the paper or pull-out component according to medicine name, strength and prescription number by row, with columns according to date prescribed and initials of prescriber, appearance, indication, intended result, special considerations and/or monitoring parameters, and possible side effects.

### CROSS-REFERENCE TO RELATED APPLICATIONS

This application claims the benefit of PPA Ser. No. 62/282,225.

### BACKGROUND

The following is a tabulation of some prior art that presently appears relevant:

| | | | |
|---|---|---|---|
| 6,860,390 | A1 | 2005 Mar. 1 | Bowman |
| 7,228,970 | A1 | 2007 Jun. 12 | Holmberg |
| 9,211,233 | A1 | 2015 Dec. 15 | Shavelsky et al |
| 6,550,618 | A1 | 2003 Apr. 22 | Peterson |
| 4,749,085 | A | 1988 Jun. 7 | Denney |
| 4,693,371 | A | 1987 Sep. 15 | Malpass |
| 8,253,561 | A1 | 2012 Aug. 28 | Bowers |
| 8,670,865 | A1 | 2014 Mar. 11 | Coe |
| 5,838,224 | A | 1998 Nov. 17 | Andrews |
| 7,240,793 | A1 | 2007 Apr. 10 | McBain |
| 7,926,850 | B1 | 2011 Apr. 19 | Muncy |
| 7,900,772 | B2 | 2011 Mar. 8 | Sack et al |
| 5,240,113 | A | 1993 Aug. 31 | Gibilisco |
| 5,058,736 | A | 1991 Oct. 22 | Bedol |
| 6,004,060 | A | 1999 Dec. 21 | Bedol |
| 6,095,564 | A | 2000 Aug. 1 | Wien |
| 8,522,964 | B1 | 2013 Sep. 3 | Pledger |
| 8,141,721 | B2 | 2012 Mar. 27 | Harris-Bowman |
| 7,676,744 | B1 | 2010 Mar. 9 | Henderson |
| 5,209,344 | A | 1993 May 11 | Smith |
| 8,727,110 | B2 | 2014 May 20 | Walsh |
| 4,270,754 | A | 1981 May 23 | Alex |

| | | | |
|---|---|---|---|
| 20130037428 | A1 | 2013 Feb. 14 | Wingate, III |
| 20110108451 | A1 | 2011 May 12 | Sack et al |
| 20030059248 | A1 | 2003 Mar. 27 | Walton et al |
| 20090206085 | A1 | 2009 Aug. 20 | Schenker et al |
| 20110052310 | A1 | 2011 Mar. 3 | Jansen et al |
| 20160071434 | A1 | 2016 Mar. 10 | Turner |
| 20100304348 | A1 | 2010 Feb. 12 | Shlomo |

| | | | |
|---|---|---|---|
| 2016/028747 | A1 | 2016 Feb. 25 | Terhune et al |
| 2016/118605 | A1 | 2016 Jul. 28 | Terhune et al |
| 02111547 | A | 1998 May 20 | Karpenko |
| 2,770,014 | | 2006 Apr. 5 | Shi |

The need for storing and organizing small items or substances presents itself in many spheres of activity, including pharmaceutical, culinary, office management, agricultural, cosmetics, carpentry, arts and crafts as well as mechanical, biological, chemical and electrical engineering fields. The present art relates to a storage organizer suited to efficiently store, organize and characterize substances and small items, such as medicine, jewelry, herbs, seeds, or paints used by an artist. The present art may also be used an educational tool by allowing users to characterize stored items through indicium according to a matrix and submatrix arrangement.

With respect to the storage of medicines, many people often use several prescription medicines and over-the-counter supplements daily in the treatment and prevention of disease. When several medicines and supplements are used together, the likelihood of a person using them incorrectly or discontinuing them without prescriber supervision increases, often in proportion to a sense of being overwhelmed or confused. Additionally, people often forget to take their medicine, or when taking them regularly, confuse whether they've actually taken them with a dose administered at the same time on a previous day.

Medicine organizers and systems of organization have been developed to help users avoid missing or duplicating doses, partly through providing a cue of whether or not the medicine in question has been taken. Similarly, when storing and organizing medicine for administration, attempts have been made to improve patient compliance by allowing the user or caregiver to visually organize and store medicine according to time of day and day of the week. Specialized labels, charts and blister dose packages have also been developed to further facilitate patient compliance and improve the quality of healthcare.

U.S. Pat. App. 0037428 relates to a zippered portfolio wherein bottles of medicine may be stored along with a calendar, a medication list, office questions, a flash drive and a weekly pill box containing two administration times: “AM” and “PM.” Each time is accorded one row, while seven columns allow for organization according to day of the week, encompassing a matrix.

U.S. Pat. No. 6,860,390 has a similar arrangement but comprises three possible administration times: morning, noon and evening. U.S. Pat. No. 7,228,970; U.S. Pat. No. 9,211,233; U.S. Pat. No. 6,550,618; and U.S. Pat. No. 4,749,085 are similar but include one additional administration time: bedtime.

U.S. Pat. No. 4,693,371 demonstrates a total of six administration times, two for morning and evening and one for lunch and bedtime, while U.S. Pat. App. 0184024 presents a foldable organizer with a potentially unlimited number of administration times.

U.S. Pat. Nos. 4,573,580 and 8,253,561 also relate to matrix-oriented organizers, with the latter being electronic and expandable, thereby offering a potentially unlimited number of administration times, while U.S. Pat. No. 8,670,865 presents an electronic, interactive medicine organizer wherein compartments are arranged circularly.

The present art allows each medicine to be organized in columns according to specific times of administration, while the paper or pull-out component situated beneath stored items allows columns of administration times to be further stratified according to medicine name. This enables each medicine to receive a separate compartment rather than lumping them together in the same compartment according to administration time.

Being able to organize medicines according to a specific administration time assists a user in avoiding an interaction related to taking medicine with special precautions, such as without food, two hours before or four hours after food or another medicine. Being able to label organized medicines according to their name helps a user establish greater familiarity with their medicine, which helps to reduce the risk of a medicine error. Additionally, the paper or pull-out component can further assist a user in readily identifying other important characteristics of their medicine, such as strength, which provider prescribed it and when, its appearance, what its used for, the intended result, any special considerations or monitoring parameters as well as any possible side effects. Such details, when readily accessible and understood, can help to increase compliance as well as the safe and effective use of medicines.

Because the present's combination of labeling space directly above columns for administration times along with labeling space on the paper or pull-out component for the name of individual medicines allows customization not only according to a specific time of administration but according to an “as needed” frequency. Organizing medicines according to an “as needed” frequency allows a user to easily keep track of how much medicine has been used within a 24-hour period. For example, hospice patients often receive intensive, low-cost, palliative therapies, sometimes as often as every two or three hours. Within a 24-hour period, it is easy for such a patient or caregiver to be overwhelmed or forget to record the amount of medicine they've used. However, such usage histories are helpful for prescribers in properly prescribing a stronger or longer acting medicine in order to reduce periods of pain or discomfort. This feature can also be helpful in situations where a patient has several caregivers who are not communicating well with each other or regularly charting usage histories. None of the prior art examples address this problem.

Furthermore, because the present art encompasses placement within a binder, organizers can be stacked upon one another and stored within the same notebook. This functionality, with some embodiments, allows for the organization of up to 56 individually stored medicines, or medicine taking events, within a 4″ notebook. While the organization and storage of this many medicines, or medicine taking events, may never be necessary, there are many patients who regularly use over 14 medicines daily. Conversely, if a user has fewer than 15 medicines, or medicine taking events per day, they could conveniently organize and store four weeks' worth of medicine in the same 4″ notebook.

With respect to art forms presenting alternative systems of medicine organization, whereby specific details of an individual medicine may be observed by the user in order to increase familiarity with the medicine and the medicine regimen as a whole, U.S. Pat. No. 5,838,224 accommodates up to eight administration times, or medicine taking events, in an organizer designed to hang on a wall with a “note/instruction pad.” However, the art form is limited in that if a user has several medicines they receive at the same time, they would likely combine all of those medicines into the same medicine drawer, engendering the limitations seen with prior art previously discussed while also limiting the amount of space available for specific details about individual medicines on the note/instruction pad. Conversely, to store each kind of medicine individually, they'd need to devote another drawer to each medicine, thereby duplicating the electronic alarm features of the art, reducing efficiency and adding unnecessary costs. Also, because the system involves combining the same type of medicine together in one drawer, generally one for each day of the week, a user would rely on the electronic components to indicate whether a dose has been administered, count the medicines remaining in the drawer, or routinely make some kind of mark on the note/instruction pad to record whether a medicine has actually been taken. In contrast, the present art allows a user to easily ascertain whether or not a medicine has been administered on a given day at a specific time by simply looking to see if the compartment or container corresponding to the correct time, name and day of the week, contains the medicine or not.

U.S. Pat. No. 7,240,793 relates to a weekly charting system, wherein columns on the chart are organized according to medicine characteristics, such as administration time, indication, prescription number and refill date, while rows are organized according to the name of the medicine and its appearance. A user may then establish a correspondence with medicines labeled on the chart by applying pre-numbered stickers to the appropriate medicine bottle caps.

U.S. Pat. No. 7,926,850 presents a system that includes the use of a binder, wherein supplicate copies of prescription labels may be stored. A user may apply symbols in the form of stickers to said labels and to labels on the containers of individual bottles of medicine, whereby a correspondence may exist to facilitate an understanding of a medication regimen.

While both of the previous art forms address a method of organizing informational characteristics of a variety of medicines and their appropriate administration, they do so in a manner that is not directly connected with the physical arrangement of the medicines or supplements. Moreover, the present art allows a visible correlation to exist between their arrangement and their informational characteristics, efficiently and conveniently assisting the user in becoming familiar with their medicines and specific details concerning their safe and effective use.

Additionally, with respect to patent '850, because the present art allows for the visible storage of several unit doses of the same medicine in the same compartment or container according to a specific time of administration, as well as any other times of administration throughout the day, the need for the use of symbols as stickers to relate such information is unnecessary.

With respect to patent '793, some medicines have characteristics that are too detailed to be contained within a reasonably sized one-piece chart, a situation that also limits the aforementioned note/instruction pad of patent '224. Because of the present art's functionality, with respect to fitting within a loose-leaf ring binder, when such supplemental information does not fit on a standard sized piece of paper or the pull out component, it may be readily indexed by page number or tabbed category on the paper or the pull out component and then accessed through being stored and organized alongside stored medicines in the same binder. Such information might include mechanisms of action and studies evaluating safety, efficacy, risks and benefits. Other pertinent information could comprise facts about a user's health condition(s) and advances that are being made in treatment options, past treatment success, monitoring logs, such as blood sugar or blood pressure, and short and long-term therapy goals.

Int. Patent No. 2016028747 relates to a medication packaging and dose regimen system. As with similar art forms discussed, this art enables a potentially unlimited number of administration times. Furthermore, the art enables specific details of an individual medicine to be observed by the user, whether through indicia or an information insert, making the art comparable to the three prior examples wherein a user is assisted in becoming more familiar with their medicines. This is also the case for Int. Patent No. 2016118605.

However, neither art form contains the means, nor addresses a method, whereby the uniform arrangement of individual types of medicines as columns correspond with rows on the medication insert or on another “unit dose page,” whereby the name of the medicine is observed through a locational correspondence, and where additional pertinent information concerning a given medicine can be further ascertained by fields of information arranged as columns. Similarly, the art does not address an informational template whereby particular characteristics of a medicine are arranged into fields as columns, with the name of each medicine according to one row, whereby said row corresponds with a column of medicine arranged directly above and capable of running parallel to one another.

Additionally, although the art describes a stackable “medicament dispensing system,” it does not do so in a manner that occurs within a loose-leaf binder or notebook wherein the means for establishing the aforementioned correspondence exists as a feature of the organizing unit itself, whether as a “unit dose page” or “medicament dispensing system.” Accordingly, if a user had a “unit dose page” or “medicament dispensing system” within a binder, which are held in place through the rings of the binder, and a second “unit dose page” with indicia or an “informational insert,” situated beneath the first “unit dose page”, there is no method nor means whereby a sliding durational correspondence may occur between the information presented on the second “unit dose page,” or information insert, and a row or column of containers or blister packs of medicine on the first “unit dose page.” Similarly, as shown in FIG. 31 of the art, wherein a pocket exists within a “medicament dispensing container,” there is no system addressed wherein a sliding durational correspondence may exist between one “unit dose page” and another, or an information insert, making this art similar to the previous art forms discussed wherein a visible correlation does not exist between the arrangement of medicine and important informational characteristics concerning them. This is also the case for the unit dose container and packaging of U.S. Pat. No. 7,900,772 and US. Pat. App. 20110108451, respectively.

Furthermore, the aforementioned art forms do not address a means for exposing compartments individually through the use of a sliding lid, whereby the removal of a container or the contents of a compartment can be facilitated through turning the organizer on its side or upside down. Accordingly, users who have difficulty removing a medicine or combination of medicines from a blister pack or receptacle due to a lack of finger strength or dexterity would find the present art easier to use. However, U.S. Pat. No. 5,240,113 does address the use of a sliding lid whereby a user's individual medicines may be exposed one compartment at a time. Nonetheless, in addition to other features not present in comparison to the present art, patent '113 does not address a means for providing resistance to the sliding lid in accordance with access to a given compartment, whereby said lid may stay in place over a given compartment as the organizer is turned on its side or upside down. In contrast, a user would have to manually hold a lid in place as they turn the organizer, which may be too difficult for users lacking dexterity or hand and finger strength. Additionally, patent '113 does not establish a means whereby each lid may be locked into place individually when fully closed. Conversely, the present art entails the availability of two securing features, one wherein each lid is locked individually and another wherein a child-proofing lock and strap, commonly used on cupboards and cabinets, can be affixed to the outside covers of the binder so that it may remain locked shut when the binder is closed.

Lastly, the present art encompasses an embodiment wherein informational characteristics of medicines may be displayed through a tablet computer that fits within the opening also used for paper or the pull-out component. Thus, a user can readily store past therapies and access information related to their medicines in a manner that is potentially more efficient, depending on a user's familiarity with operating a tablet computer, than addressed by the aforementioned art examples.

With respect to other storage organizers designed to fit within a notebook, U.S. Pat. No. 5,058,736 presents such an organizer for use by businessmen and/or students in organizing pencils, pens, postage stamps, business cards and the like. However, said art doesn't allow customization through the use of removable sidewalls and containers, nor does it address an arrangement of compartments or removable containers into a plurality of columns and rows so that items may be arranged according to distinct categories for efficient organization. This is also the case for U.S. Pat. No. 6,004,060, an organizer developed by the same inventor that encompasses a modular system whereby users may configure electronic devices.

U.S. Pat. No. 6,095,564 relates to a partitioned binder assembly comprising separate storage arrangements or pockets for organizing items, such a book, writing utensils and a calculator. Patent App. No. 20030059248 demonstrates a substrate capable of incorporation within a binder, such as a three-hole punched notebook divider insert, comprising a series of compartments for organizing and storing small cards, such as flashcard and business cards, while US20090206085 relates to an item holder capable of being incorporated into a binder and used to organize various supplies, such as scissors, a pen and a calculator. US Pat. App. 20110052310 presents a medical information and directives device comprising a medication display and information board housed within a binder, whereby descriptions and samples of medications may be stored and reviewed. Nonetheless, none of these art forms that relate to organizing items within a binder provide a method for storing items according to a plurality of columns and rows, whereby said items may be efficiently organized in a matrix format according to informational characteristics via labeling space adjacent to columns and rows, with additional informational characteristics efficiently visible through a sub-matrix, as accomplished through the paper or pull-out feature of the present art.

In relation to art forms used in storing and organizing jewelry, U.S. Pat. No. 8,522,964 presents an enclosable case with the means for storing several earrings or rings within separate labeled compartments. U.S. Pat. No. 8,141,721 relates to an enclosable case with the means for organizing, storing and transporting jewelry, wherein a planar base with a plurality of openings and rods allows bracelets, necklaces, rings and earrings to be stored. U.S. Pat. No. 7,673,744 demonstrates an enclosable case with the means for storing earrings or rings within said case. U.S. Pat. No. 5,209,344 relates to an organizer for jewelry comprising a plurality of pockets, wherein the organizer may hang in a closet from a clothes hanger. U.S. Pat. No. 8,727,110 exemplifies an elongated rectangular sheet comprising a plurality of tab closures, ring bars and at least one jewelry pocket for retaining jewelry.

The present art allows for organization of earrings and rings according to a matrix format, wherein categorization may occur according characteristics readily identifiably through the use of labeling space adjacent to columns and rows, with further stratification and characterization readily accessible through the paper or pull-out component. Furthermore, the present art allows for efficient organization and characterization of unfinished items of jewelry, such as individual gems, pearls or beads. Similarly, a user may wish to organize multiple items according to type of material, features, cost, or shape, aspects that may be further stratified by using the paper or pull-out component. For example, a user may have different types of gems they wish to organize. Each column on the base sheet could be labeled according to type of gem with rows labeled according to shape or type of cut. Then, rows on the paper or pull-out component could stratify columns on the base sheet according to a range for carat weight, while columns allow for further characterization, such as refractive index, colors(s), specific gravity, hardness, dispersion, chemical composition, look-alikes and location of origin.

Additionally, none of the aforementioned art forms provide a means to efficiently store and organize related documentation alongside the jewelry as could be accomplished through the present art through the organizer's incorporation within a binder. Such information might include details concerning method and location of refinement, location of origin, chain of ownership, cost or sale price, as well as details related to refining, collecting or creating jewelry.

With respect to using the organizer to sort and store seeds for agricultural use, many gardeners and farmers often work with different types of seed. They may collect seeds from their own crops after experimenting with different growing mediums or fertilizers, or after exposing them to certain plants capable of cross-pollinating. Several embodiments of the present allow efficient organization of seed types. For example, an arrangement of seeds may occur by type according to rows on the base sheet, with further differentiation according to when the seed was cultivated according to columns. Additional characteristics may be exemplified according to rows on the paper or pull-out component, such as features of the plant particular to the seed source, whether color of flower or nearby plant intended for cross-pollination. Furthermore, containers could be used to store potting soil or germination substrate, whereby seeds may be germinated while stored and sorted upon the base sheet, helping gardeners and farmers to grow a variety of plants easily and insightfully.

With respect to using the organizer to store paints, artists often experiment with mixing paint colors to produce new color variations. Several embodiments of the present art allow for the efficient organization of paints with varying colors. For example, an artist may organize and label columns on the base sheet according to a specific color, each row according to an incremental amount of another color, such as white, with columns on the organizer further stratified by addition of another color of a specified amount according to rows on the paper or pull-out component.

With respect to art forms utilizing one or more matrices as educational tools, US Pat. App. 20160071434 relates to a visual education aid for teaching stages of a medical condition while US Pat. App. 20100304348 relates to an educational and training tool using matching techniques within a game matrix.

Devices that include a matrix and at least one sub-matrix combination include Int. RU Pat. 02111547, a device for evaluation of student knowledge. Said device comprises cells on an answer sheet and testing palette, wherein said palette is mounted in such a way to allow for cell movement and correspondence with cells on the answer sheet. CN Pt. No. 2770014 relates to multifunctional teaching board comprising a flat plate with holes arranged into a square matrix whereby digits may be discerned through said holes, according to patterns, for mathematical studies.

U.S. Pat. No. 4,270,754 presents an amusement device which may be used as an educational spelling tool, comprising a base structure having an upper playing board formed with a plurality of windows, potentially arranged in a matrix pattern of rows and columns, with one or more rotary discs mounted below the playing board or base, whereby content on the disk may be viewable through openings in the board.

None of these examples of prior art demonstrate the use of a compartment or container system arranged into a matrix with labeling space for columns and rows and a sub-matrix for further identification and characterization of physically stored items. Thus, the present art enables usage as an educational tool that assists in forming associations between abstract informational characteristics and sensory information, whether tactile, visual, taste, scent and/or auditory. For example, a series of pine needles from different varieties of pine trees could be arranged in a top row with each column corresponding to the name of the tree from where the needles came. Some of these columns could be further stratified through the use of rows on the paper or pull-out component according to a sub-type of the principle tree, such as a cross-pollinated offspring. Because each compartment of needles may have unique sensory characteristics, whether size, color, smell or shape, assimilation of that knowledge is aided. Additional rows beneath the top row could contain other unique components of the tree, such as pieces of wood, bark, seeds and pine cone pieces. Meanwhile, abstract characteristics pertaining to each tree, such as location, density and growing characteristics could be stored and organized on the paper or pull-out component, arranged into columns, whether presented or displayed directly through indicium or indexed by page number or tabbed category according to documents stored within the same binder.

### SUMMARY

This invention relates to a storage organizer comprising a planar base sheet with the means for the attachment and removal of sidewalls and containers, or permanently attached sidewalls in combination with the means for the attachment and removal of additional sidewalls, whereby a series of compartments may be formed as a plurality of rows and columns. The organizer contains the means for a paper or pull-out component allowing a submatrix whereby further identification and characterization of stored items may occur. The organizer may be confined within a variety of loose-leaf ring binders, facilitating the storage and retrieval of documentation related to stored items, which themselves may be indexed through the use of the paper or pull-out component.

Several embodiments of the organizer enable 14 compartments, or removable containers, to be organized and labeled according to the contents of each column, with seven rows per column, for a total of 98 compartments per organizer. Additional items may be efficiently stored through stacking multiple organizers in the same notebook —up to 392 compartments in a 4″ notebook in one embodiment.

All embodiments of the organizer encompass an opening for the use of a paper or pull-out feature situated beneath stored items. This opening allows for stratification of columns of stored contents on the base sheet, wherein a stored item accords with a specified row on the paper or pull-out component, while additional informational characteristics of that item may be readily accessed according to fields of information organized as columns on the paper or pull-out component. Thus, at least four sets of informational characteristics may be used in the organization, storage and review of characteristics of items or substances stored. Some embodiments comprise an opening capable of receiving a tablet computer, whereby fields of information pertaining to stored content may more readily be stored and retrieved.

When the organizer is used to store medicines, medicines may be arranged in the organizer according to administration time or frequency as columns with days of the week as rows, while the name of the medicine may be readily stored and accessed through use of rows on the paper or pull-out component, with columns on said paper or pull-out component used for other informational characteristics of the medicine, such as prescription number, date prescribed, initials of prescriber, appearance, indication, intended result, special considerations, monitoring parameters and side possible effects. Additionally, the availability of labeling space on several embodiments of the organizer allows indicium or labeling for the arrangement of medicines according to “as needed” frequencies. Thus, within a 24-hour period, users may efficiently ascertain how much of a given medicine was used, thereby enabling a prescriber to more effectively prescribe higher doses or long-acting medicines when appropriate.

### DRAWINGS—FIGURES

FIG. 1 is an exploded view of a first embodiment for a base sheet.

FIG. 2 is a perspective view of the first embodiment for a base sheet.

FIG. 3 is a second exploded view of the first embodiment for a base sheet.

FIG. 4 is an exploded view showing the first embodiment for a base sheet with a sliding lid

FIG. 5 is a perspective view showing two base sheets joined together.

FIG. 6 is an exploded view of a sliding lid with securing pegs.

FIG. 7A is an exploded view of a first embodiment for a pull-out component.

FIG. 7B is an exploded view of a second embodiment for a pull-out component.

FIG. 7C is an exploded view of the bottom-side of the second embodiment of the pull-out component.

FIG. 8 is an exploded view of a second embodiment for the top section of a base sheet with removable interior latitudinal sidewalls.

FIG. 9 is an exploded view of a second embodiment for the top section of a base sheet with a second embodiment for a sliding lid.

FIG. 10 is an exploded view of a fourth embodiment for the top section of a base sheet with an embodiment for a sliding lid retaining component.

FIG. 11 is a perspective view of a third embodiment for a sliding lid.

FIG. 12 is an exploded view of the fourth embodiment for the top section of a base sheet with an embodiment for a lid closure component and a second embodiment of an interior removable latitudinal sidewall.

FIG. 13 is an exploded view of the top and bottom sections of a lid retaining component.

FIG. 14 is a perspective view of the left-topside corner of the top section of the fourth embodiment for a base sheet.

FIG. 15 is an exploded view of the fourth embodiment of a base sheet comprising the top and bottom sections.

FIG. 16 is a perspective view of the top section of the second embodiment for a base sheet and a first embodiment for a non-sliding removable lid.

FIG. 17 is a perspective view of a means for pivotally connecting a lid to a base sheet.

FIG. 18 is a perspective view of a means for securing a lid to a base sheet.

FIG. 19 is a perspective view of the top section of the second embodiment for a base sheet with a contiguous lid embodiment.

FIG. 20 is a perspective view of the top section of the second embodiment for a base sheet and a second embodiment for contiguous lids.

FIG. 21 is a perspective view of a fifth embodiment for the top section of a base sheet.

FIG. 22 is an exploded view of the first embodiment for a removable container comprising a body, lid and bottom section.

FIG. 23 is an exploded view of the fifth embodiment for the top section of a base sheet with several containers of the first embodiment for a removable container.

FIG. 24 is a perspective view of three top sections of a base sheet of the fifth embodiment stacked upon one another in a binder with containers of the first embodiment for a removable container.

FIG. 25 is an exploded view of a second embodiment for a removable container comprising a body, lid and bottom section.

FIG. 26 is an exploded view of a third embodiment for a container.

FIG. 27 is a second exploded view of the third embodiment for a container.

FIG. 28 is an exploded view of a sixth embodiment for the top section of a base sheet along with the second embodiment for a container and an embodiment for specialized tweezers.

FIG. 29 is a bird's eye view of a seventh embodiment for the top section of a base sheet with a piece of paper as a pull-out component.

FIG. 30 is a perspective view of the top and bottom sections of the seventh embodiment for a base sheet with a tablet computer as a pull-out component.

FIG. 31 is a bird's eye view of a template for indicia on the paper or pull-out component when the organizer is used to store and organize medicines.

### REFERENCE NUMERALS

100 the first embodiment for a base sheet; 101 openings for rings of a binder; 102 T-shaped channels for longitudinal sidewalls; 103 space for labeling rows of stored items; 104 space for labeling columns of stored items; 106 longitudinal sidewalls with T-shaped protrusions; 108 T-shaped protrusions on longitudinal sidewalls; 110 pegs on the base sheet; 112 a ring securing component; 114 pegs on the ring securing component; 116 peg receptacles on a latitudinal sidewall; 118 an exterior latitudinal sidewall; 122 peg receptacles on the base sheet; 124 the first embodiment for a sliding lid; 126 protrusions that form a channel for sliding lids; 127 channels on longitudinal sidewalls for sliding lids; 128 protrusions on longitudinal sidewalls for removable interior latitudinal sidewalls; 129 channels on longitudinal sidewalls for removable interior latitudinal sidewalls; 131 peg-receptacles on one edge of a lid; 132 pegs on one edge of a lid; 133 a handle for a lid used with a base sheet; 135 removable interior latitudinal sidewalls; 136 openings on latitudinal sidewalls for securing lids; 137 an opening on a lid for a T-shaped peg; 138 two protrusions on the bottom face of a lid; 139 a T-shaped peg for securing lids; 142 the first embodiment for a pull-out component; 144 an opening for receiving a pull-out component; 146 second embodiment for a pull-out component; 148 hook-like protrusions on the pull-out component; 150 a blockage for the hook-like protrusions of the pull-out component; 152 a stop-protrusion on the pull-out component; 154 a wedge on the bottom face of the pull-out component; 201 the top section of a second embodiment for a base sheet; 204 permanently attached outer and inner longitudinal sidewalls; 208 permanently attached outer latitudinal sidewalls; 251 the top section of a third embodiment for a base sheet; 252 a second embodiment for a sliding lid; 301 the top section of a fourth embodiment for a base sheet; 302 the first embodiment for a bottom section of a base sheet; 314 a lid retaining component; 316 pegs on the lid retaining component; 318 a hole on the lid retaining component; 320 peg-receptacles on longitudinal sidewalls for securing the lid retaining component; 323 a permanently attached latitudinal sidewall; 322 a hole on longitudinal sidewalls for securing the lid retaining component; 324 primary protrusions on the channels for sliding lids; 326 a third embodiment for a sliding lid; 328 flexible arms on a sliding lid; 330 secondary protrusions on flexible arms of a sliding lid; 334 an indention for securing a sliding lid; 336 removable interior latitudinal sidewalls that span all rows; 340 a lid closure component; 342 the top section of the lid retaining component; 344 the bottom section of the lid retaining component; 346 a clasp on the lid retaining component for securing lids; 348 the female component of a hinge pivotally connecting the top and bottom sections of the lid securing component; 349 the male component of a hinge pivotally connecting the top and bottom sections of the lid securing component; 350 an indention for receiving the lid securing component; 352 a hole for securing the lid securing component with a screw; 354 an embodiment for an opening for a binder ring; 358 an incline for creating friction against the paper or pull-out component; 360 holes for securing the top and bottom sections of the base sheet together with a screw; 362 protrusions for guiding sheets of paper or the pull-out component into the opening; 364 an indention to ease grasping the paper or pull-out component for removal; 366 curved protrusions for facilitating paper or the pull-out component into the opening; 368 the first embodiment for a pivotally opening lid; 370 a second embodiment for a pivotally opening lid; 372 a third embodiment for a pivotally opening lid; 401 a fifth embodiment for the top section of a base sheet; 403 peg-like protrusions for securing containers; 602 the first embodiment for a container body; 604 the first embodiment for a container lid; 606 the first embodiment for a container bottom; 607 the first embodiment for a container comprising a bottom, body and lid; 608 peg-like receptacles for securing containers to a base sheet; 609 channels formed between protrusions for a sliding container lid; 610 the upper protrusion forming a channel for a sliding container lid; 611 the bottom protrusion forming a channel for a sliding container lid 612 a handle on a container lid; 622 the second embodiment for a container body; 624 the second embodiment for a container lid; 626 the second embodiment for a container bottom; 628 peg-like protrusions on a container lid for securement to a container body; 630 peg-like receptacles on a container body for securement to a container lid; 641 the third embodiment for a container lid; 642 the third embodiment for a container body; 644 a flexible peg-like protrusion on the bottom face of a container lid for securement to a container body; 646 the gap between the bottom face of the container lid and the flexible peg-like protrusion; 648 a hand-like protrusion on the terminal end of the flexible peg-like protrusion; 650 an opening in a container body for receiving the hand-like protrusion 652 an indention on a container lid to ease opening; 654 openings on a container lid to ease removal from a base sheet; 656 an embodiment for specialized tweezers; 658 hand-like protrusions on the terminal ends of specialized tweezers; 681 the sixth embodiment for a top section of a base sheet; 682 peg-like receptacles on a base sheet for receiving a container bottom; 701 the seventh embodiment for the top section of a base sheet; 704 a letter-sized piece of paper demonstrating indicia relevant to organizing and characterizing medicines; 706 peg-like protrusions on latitudinal sidewalls for securing vertically removable lids; 708 the second embodiment for a bottom section of a base sheet;

### DETAILED DESCRIPTION

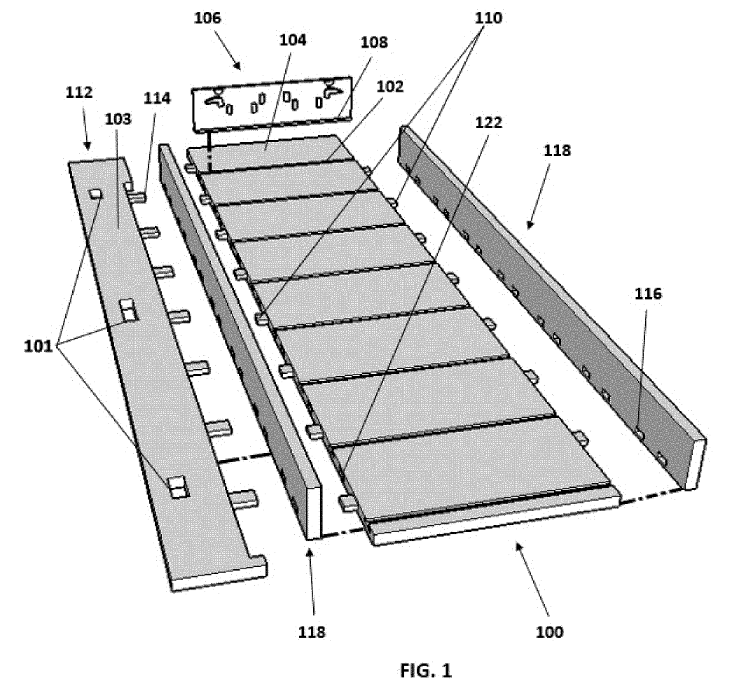

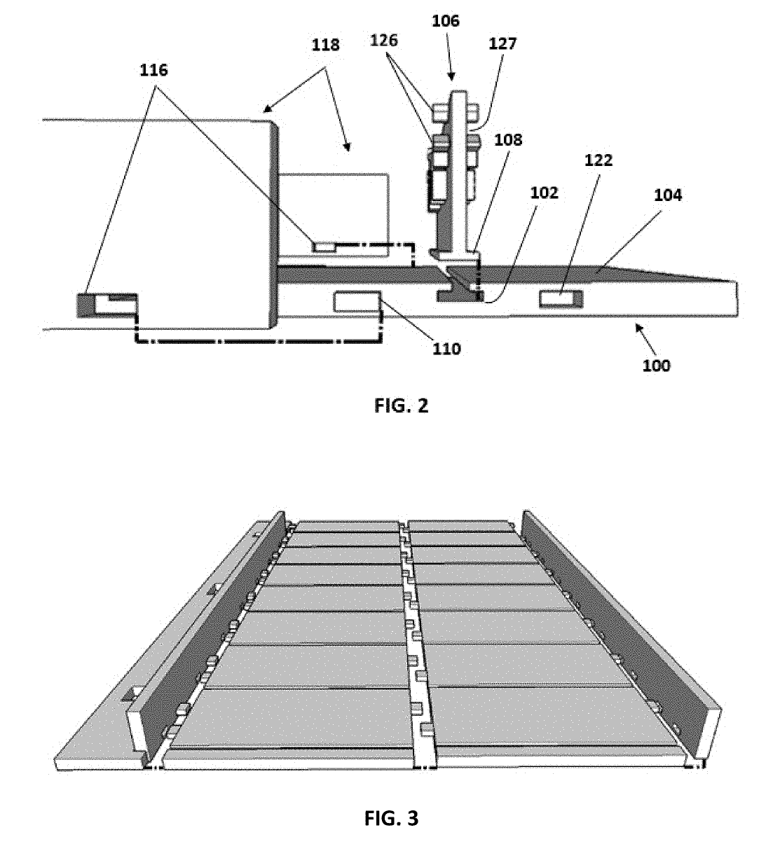

The first embodiment 100 for a base sheet is shown in FIG. 1. In this embodiment, T shaped channels 102 formed on the topside of a base sheet allow subdivided longitudinal sidewalls 106 with T shaped protrusions 108 to slide into said channels on said base sheet. This manner of securing longitudinal sidewalls to the base sheet is shown in greater detail in FIG. 2.

A ring securing component 112 designed for left side insertion to a base sheet contains pegs 114 that are long enough to slide through a peg receptacle 116 located on a latitudinal sidewall 118 and into a peg receptacle 122 on the base sheet 100. Openings 101 capable of receiving rings of a binder are shown on the ring securing component 112.

Space for longitudinal labeling 104 is located at the top of the base sheet, above stored contents, whether stored in formed compartments or in removable containers, in accordance with formed columns. Space for latitudinal labeling 103, according to row organization, is provided on the left side of the organizer, atop the ring securing component 112.

Pegs 110 on both the right and left edges of the base sheet allow latitudinal sidewalls 118 with peg receptacles 116 to fit snugly over said pegs, thus firmly securing said sidewall to said base sheet. Additional base sheets 100 may be attached to each other through said pegs 110 and adjacent peg receptacles 116, as also shown in FIG. 3.

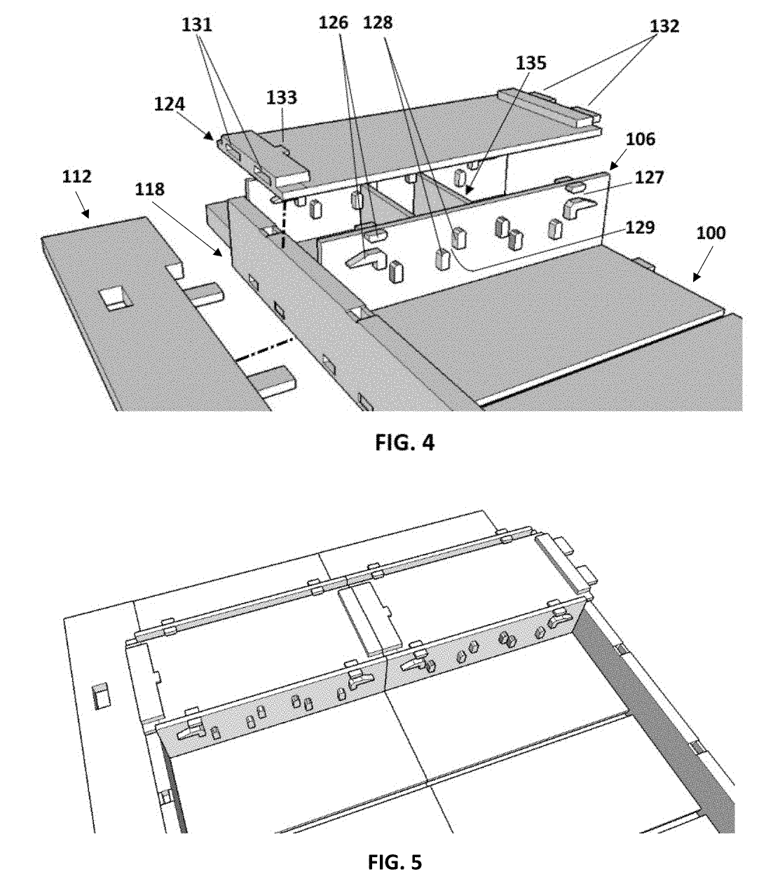

FIG. 4 demonstrates the first embodiment for a sliding lid 124 designed to be used with one base sheet 100. Said lid has pegs 132 on one side and peg receptacles 131 on the opposite side to receive said pegs, whereby lids may be joined together. Said lid slides within channels 127 formed between protrusions 126 on longitudinal sidewalls 106. Said lid contains a handle 133 to facilitate lid sliding and removal. Also shown are two removable interior latitudinal sidewalls 135. Said sidewalls slide within channels 129 formed between protrusions 128 on removable longitudinal sidewalls 106. Some of the protrusions, 126 and 128, serve a dual purpose in forming channels for interior latitudinal sidewalls as well as sliding lids. FIG. 5 shows two base sheets connected together along with two lids and longitudinal sidewalls.

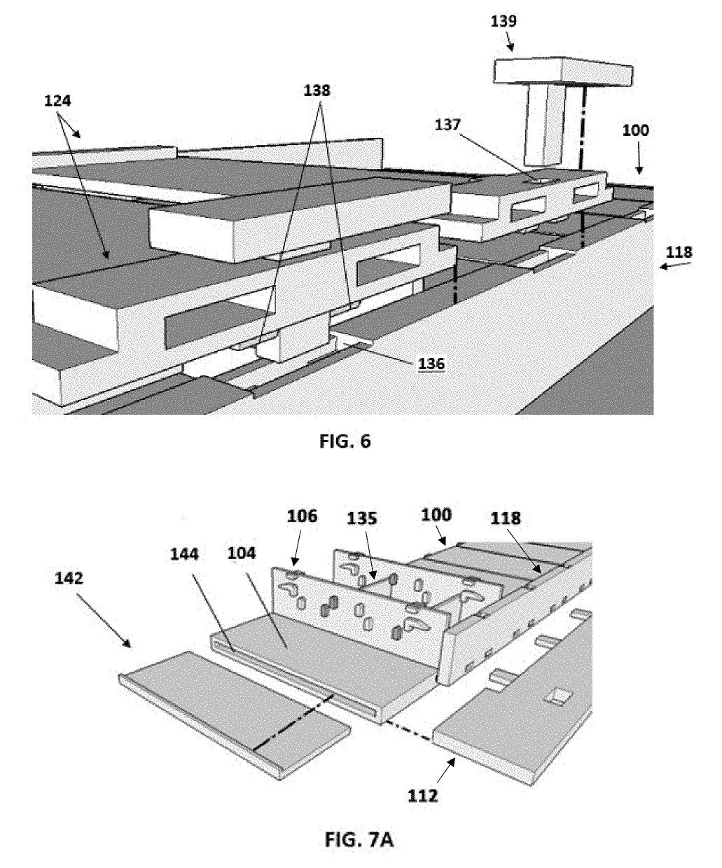

FIG. 6 demonstrates a means for a lid 124 to be secured to a latitudinal sidewall 118. In this example, a T-shaped peg 139 passes through an opening 137 near the edge of the lid and into a tapered peg receptacle 136 atop a latitudinal sidewall. The tapered peg receptacle enables the T-shaped peg to fit more and more tightly as downward force is applied. Although a square peg 139 and opening 137 are shown, a tubular embodiment is also possible, wherein threads of a bolt-like peg engage with a threaded opening. Also note in FIG. 6 two peg-like protrusions 138 on the bottom face of the lid, which fit into the opening 136 atop latitudinal sidewalls. These protrusions 138 help secure the lid even when the T-shaped peg is not used. Said protrusions are of a short enough length that they do not run into removable latitudinal sidewalls 135 when the lid is sliding.

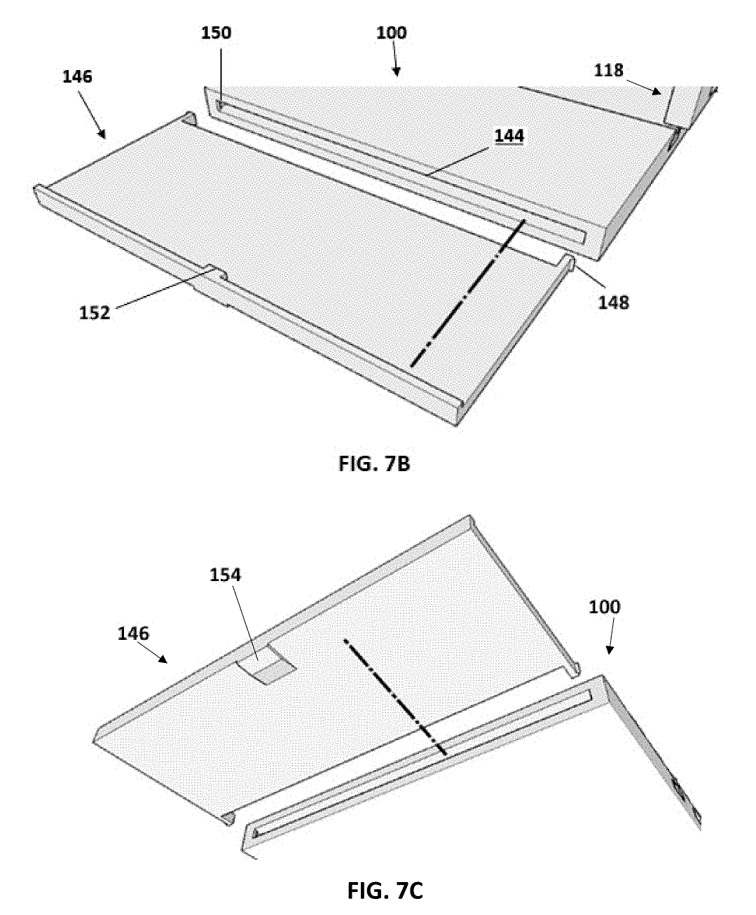

FIG. 7A is a perspective view of the base sheet 100 wherein an opening 144 alongside the top longitudinal edge is visible. Said opening allows a piece of paper or a pull-out component 142 to slide in or out of said indention. Said pull-out provides the user additional labeling space whereby contents of columns may be further understood or stratified according to indicium. Although the pull out component is shown with a relatively short length, a longer length spanning the entire latitudinal length of the base sheet may be used, potentially necessitating a base sheet of greater height or thickness in order for said pull-out to pass beneath the T-shaped channels 102. Conversely, a separate top and bottom section of the base sheet that may be affixed together, as shown in subsequent embodiments.

FIG. 7B exemplifies a second embodiment for a pull-out component 146 wherein said pull-out contains flexible arms on its right and left-side edges with hook-like protrusions 148 that prevent said pull-out from sliding all the way out of the opening 144. Accordingly, blockages 150 on the corresponding entrance locations of the opening catch the non-curved edges of the hook-like protrusions, whereby additional urging by the user is necessary to fully remove the pull-out component. Additionally, in order to prevent the pull-out from being pushed all the way in, a small stop-protrusion 152 has been formed on one edge of the pull-out. The stop-protrusion allows a small opening to remain so that a user may use his or her fingernail, or a small flathead screw driver, to readily move the pull-out from its stored position. Although not shown graphically, a user may place a piece of paper upon the pull-out component to facilitate the placement of indicia pertaining to stored contents, where said paper may be further retained through the use of adhesive on one side, such as found on a “sticky-pads,” or by using double-sided adhesive tape.

FIG. 7C is a bottom-side perspective view of the previous embodiment wherein a wedge 154 is shown. Said wedge helps to retain the pull-out in a stored position when not in use by creating frictional resistance, thereby preventing the pull-out component 146 from sliding out of the opening due to gravity.

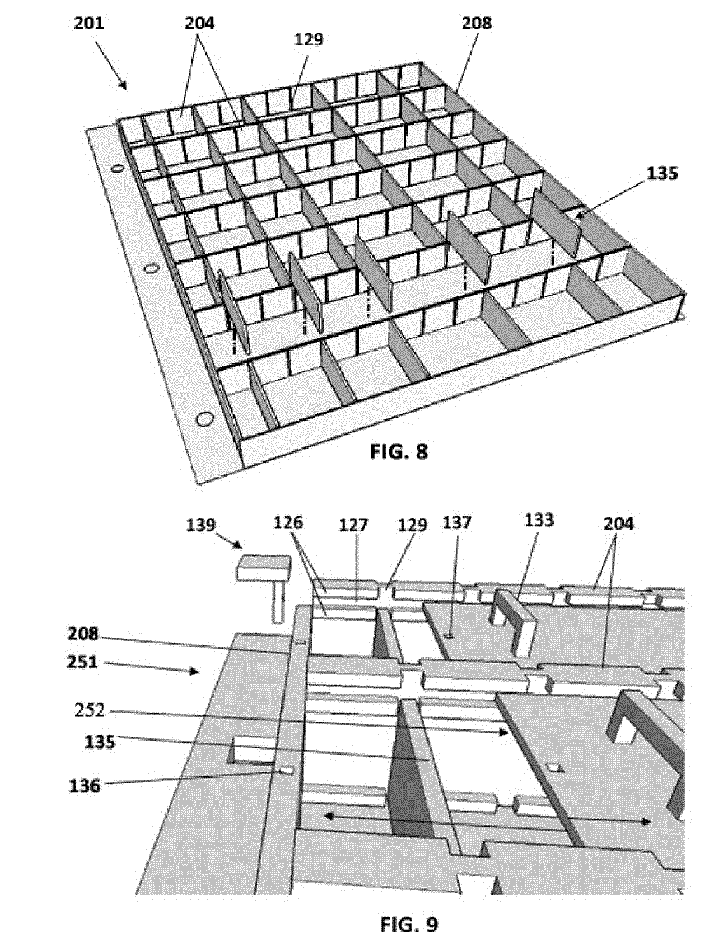

FIG. 8 shows an embodiment for the top section 201 of a base sheet, wherein all interior latitudinal sidewalls 135 are removable while outer and inner longitudinal sidewalls 204 and outer latitudinal sidewalls 208 are permanently attached to the base sheet. Note the presence of channels 129 on outer and interior longitudinal sidewalls that allow placement of interior latitudinal sidewalls.

FIG. 9 demonstrates the top section of a third embodiment for a base sheet 251. Note the presence of the channel 127 formed between two protrusions 126 near the top of permanently attached longitudinal sidewalls. A second embodiment for a sliding lid 252 is shown resting within said channels. Note also the use of a peg 139 and peg-receptacle on the lid 137 and the top of outer latitudinal sidewalls 136 to prevent lids from sliding when in a closed position during storage or transport. Also note the handle 133 on said lid.

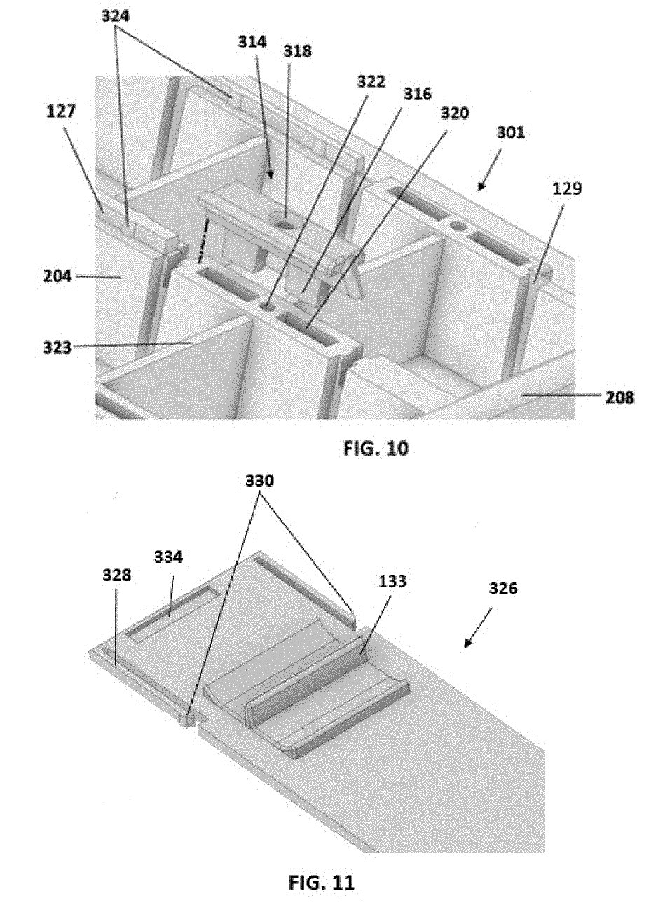

FIG. 10 presents a fourth embodiment for the top section 301 of a base sheet. Said embodiment comprises a lid retaining component 314 containing pegs 316 and a hole 318 for securement to a longitudinal sidewall. Said component eliminates the need for the topmost protrusion 126 of the aforementioned two that form a channel 127. The pegs of the lid retaining component fit within peg receptacles 320 on the top of longitudinal sidewalls, which also contains a hole 322. A screw may be passed through said holes to further secure said component to said sidewall. Note that in this embodiment some interior latitudinal sidewalls 323 are permanently attached to the top section of the base sheet. Also note the presence of primary protrusions 324 on the aforementioned channel 127, whereby sliding resistance to a lid may occur.

FIG. 11 presents a second embodiment for a sliding lid 326. Said lid contains flexible arms 328 containing secondary protrusions 330 whereby resistance occurs in combination with the aforementioned primary protrusions 324. Said lid also contains a handle 332 for ease of sliding and an indention 334 for retention.

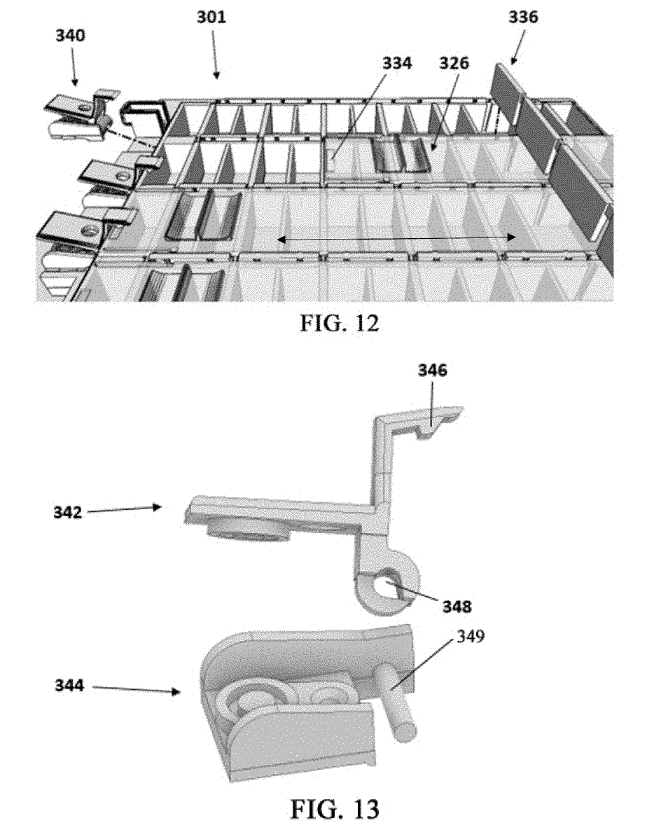

FIG. 12 is an exploded view of the top section of the fourth embodiment for a base sheet in combination with a lid closure component 340, sliding lids 326 and a second embodiment for a removable latitudinal sidewall 336. Note that said latitudinal sidewall 336 is connected as one piece through a seam running along the top wise edge. This facilitates the formation of columns that span all rows. The lid closure component 340 is comprised of a top 342 and bottom 344 section, as shown in FIG. 13. The top section 342 comprises a clasping lip 346 that fits into the aforementioned indention 334 on a lid 326. A spring is situated between the top and bottom sections applies force to push said clasping lip downward through a pivotal hinge connection comprising male 349 and female 348 parts on the top and bottom sections, respectively.

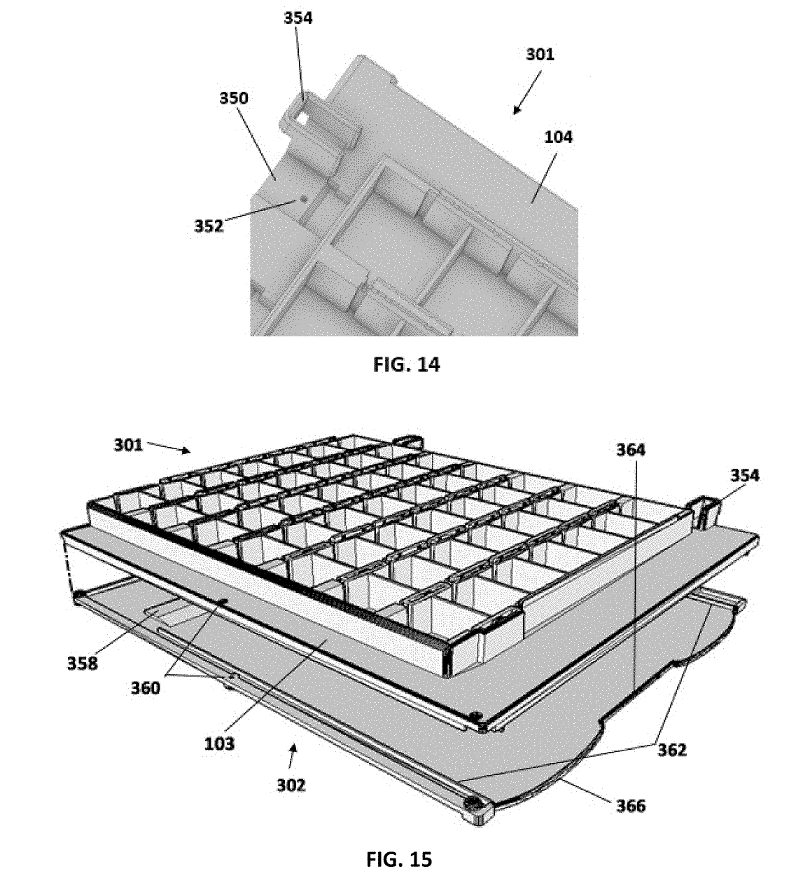

FIG. 14 shows a perspective view of a corner of the top section of said base sheet 301. Note the presence of an indention 350 for placement of the lid closure component 340. Said indention contains a hole 352 that facilitates the lid closure component to attach to said base through the use of a screw. Also note the embodiment for a ring opening 354 through which rings of a binder or notebook may enter. Said ring opening embodiment is raised above the plane of the base sheet, allowing the base sheet to rest completely flat on the interior cover of the binder while attached and retained in said binder.

FIG. 15 is another exploded view of the fourth embodiment for a base sheet, comprising a top 301 and bottom 302 section. Space for the placement of indicia or labeling for rows 103 of stored contents is shown as well as an incline 358 on the bottom piece, whereby a paper or pull-out component may encounter frictional resistance in order to avoid falling out due to gravity. Although not shown graphically, a similar incline may exist on the opposite face, so that a piece of paper encounter resistance and curves as it encounters inclines on both top and bottom sections.

Top and bottom sections contain holes 360, whereby a screw may attach said pieces together. Said bottom section also contains protrusions 362 whereby said paper or pull-out component slides along a predetermined path for alignment with columns of stored contents above. Although not shown graphically a similar protrusion exists on the bottom face of the top section to prevent a piece of paper or pull-out component from sliding any further into the opening, whereby a portion of the paper or the pull-out component is exposed outside the opening so that a user may easily grasp the paper or pull-out component for removal.

In this embodiment that the size of the opening 144 for the paper or pull-out component is large enough for a letter-sized piece of paper, 8.5″×11″.

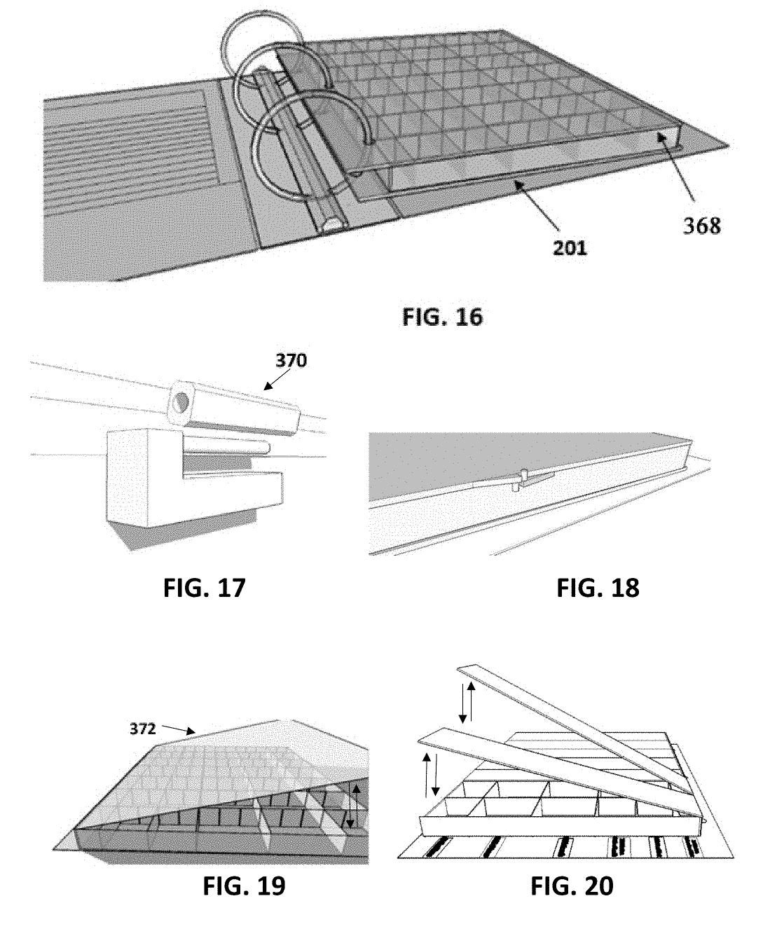

FIG. 16 returns to the top section of the third embodiment for a base sheet, showing the first embodiment 368 for a pivotally opening lid. Said lid lies flat over the organizer and is held in place through openings that receive the rings of the binder. A second embodiment for a pivotally opening lid 370 is shown in FIG. 17, wherein a hinge mechanism pivotally connects said lid to an outer sidewall. For both lid embodiments, reusable tape or Velcro can be used to secure the lid to the organizer body. Alternatively, a securing clasp may be formed onto one or more of the edges of the lid and one or more outer sidewalls, as shown in FIG. 18. Both of these lid embodiments allows a user to access all compartments and/or containers in a rapid manner.

A third embodiment for a pivotally opening lid 372, comprising a “living hinge” or seam, is shown in FIG. 19, wherein one edge of the lid is contiguous with the topside of one of the outer sidewalls. Said living hinge may comprise a thinner section of the material comprising the lid and sidewall, as shown, or a special material bonded to a non-contiguous lid and sidewall, such as nylon or rubber, thereby connecting the two. A variation of this embodiment for a lid entails the lid being subdivided so that each segment covers one row of stored contents, as shown in FIG. 20.

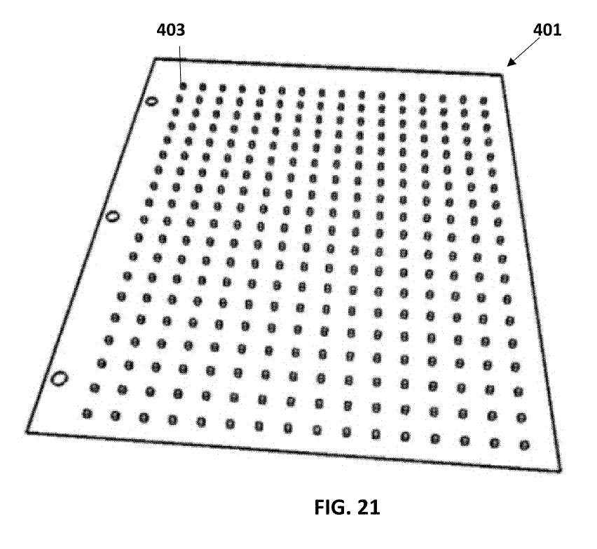

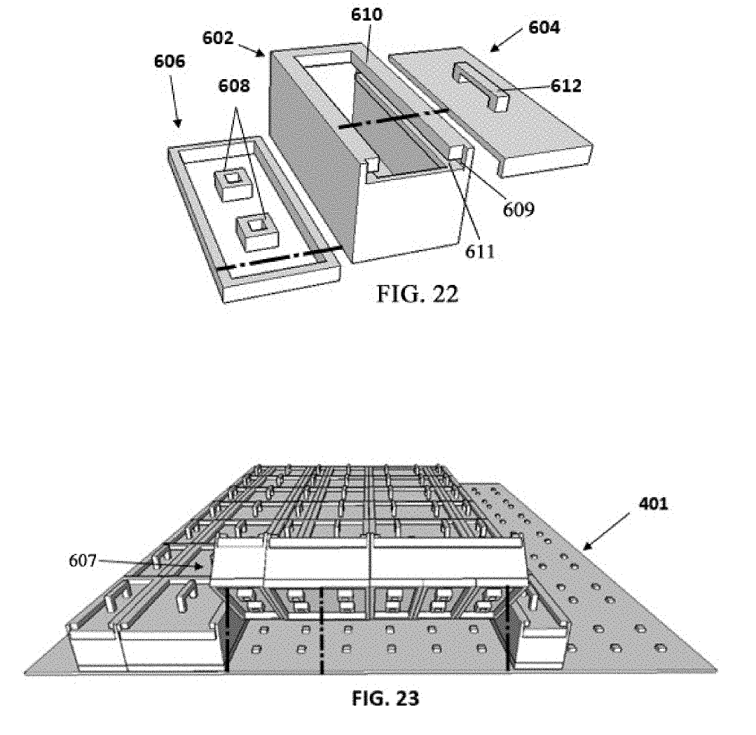

A fifth embodiment for the top section of a base sheet 401 is presented in FIG. 21. Said top section comprises a plurality of peg-like protrusions 502. Said protrusions serve to unite containers to said top section. FIG. 22 exemplifies an exploded view of the first embodiment for a container 607 comprising a body 602, a lid 604 and bottom 606. Said bottom is comprised of peg-like receptacles 608 that fit over the peg-like protrusions 403. Said container body contains top protrusions 610 and bottom protrusions 611 that form channels 609 running along the interior, whereby a lid may slide into a closed position. Also note a handle 612 on said container body to aid in opening and closing as well as removing the container from the top section of the base sheet. FIG. 23 demonstrates three containers tilted above the base sheet as well as several secured to it. Note three different embodiments for container sizes.

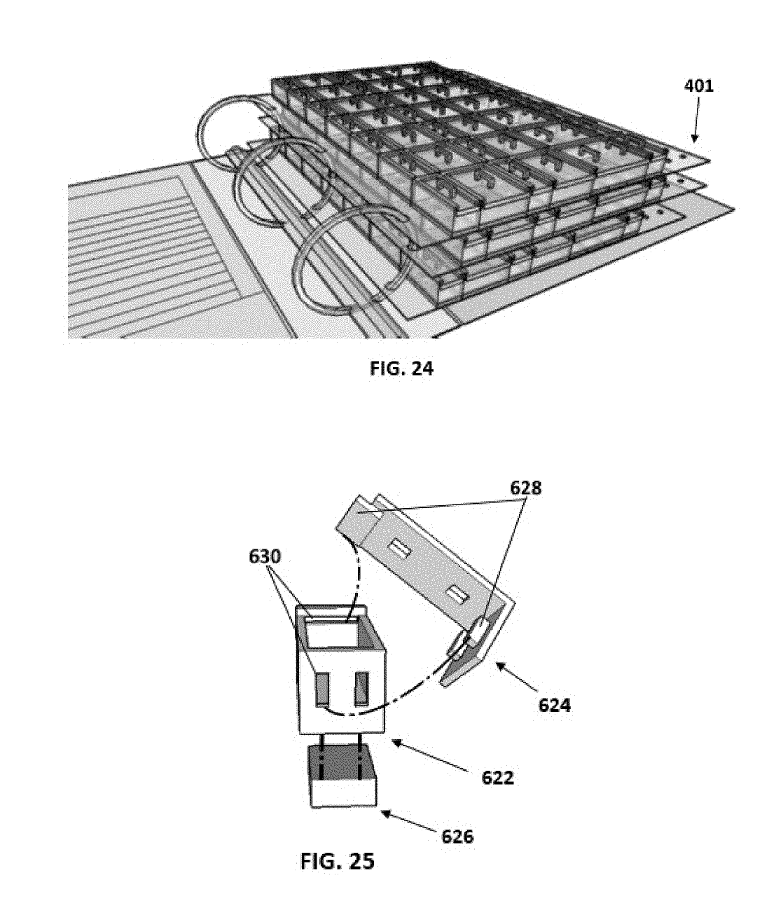

FIG. 24 is a perspective view of three top sections of the fifth embodiment for a base sheet 401 stacked upon one another while attached and retained in a three-ring binder. All of the previous base sheet embodiments also allow for a stacked arrangement, providing a large notebook is used. As an example, a 4″ notebook would accommodate three base sheets with extra space for documentation to be stored alongside.

FIG. 25 exemplifies a second embodiment 620 for a container, comprising a body 622, a lid 624 and a bottom 626. The lid of said container embodiment contains peg-like protrusions 622 that fit snugly within peg-like receptacles 624 situated on the body, allowing said lid to be secured to said body when in a closed position. Peg-like protrusions 628 on the container lid allow securement to the body through being received into peg-like receptacles 630.

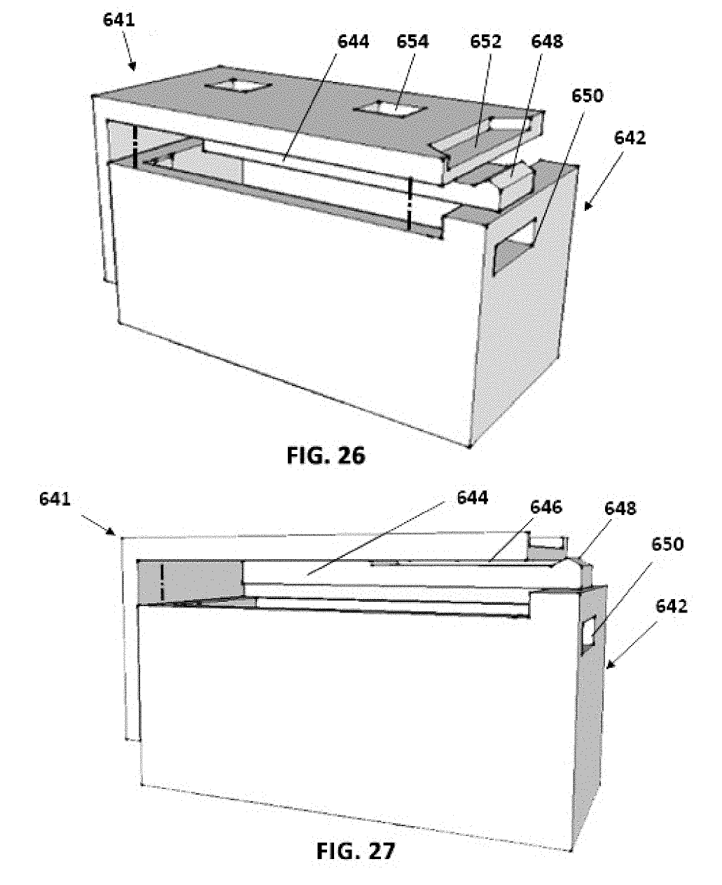

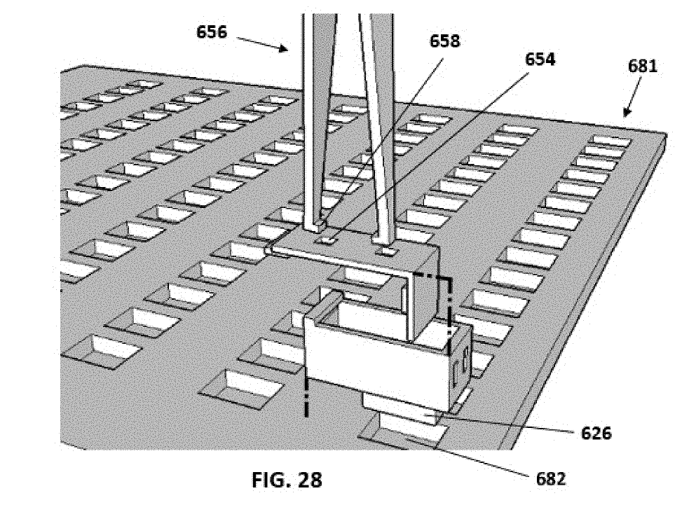

FIGS. 26 and 27 demonstrate a third embodiment for a container lid 641 and body 642. In this embodiment, a peg-like protrusion 644 on the bottom face of the lid extends towards the front of the container, separating from the bottom face for a section of its length. This separation forms a gap 646, shown in FIG. 27, allowing said protrusion to flex downward. At the terminal end of said peg-like protrusion is a hand-like protrusion 648 designed to fit within an opening 650 on the body, thus enabling said lid to snap into a closed position. Also note an indention 652 on the top side of said lid in order to aid opening the container, i.e. a user may apply their fingernail or small flathead screwdriver to pry the lid open. Lid openings 654 on the container lid allow for removal of a container from a base sheet through use of a curved pic or paper clip. Alternatively, FIG. 28 presents the bottom half of an embodiment for specialized tweezers 656 that may be used to facilitate the removal of a container. Said tweezers contain foot-like protrusions 658 on each leg. Said protrusions fit within the lid openings, allowing a lid to be grasped when the legs of the tweezers are squeezed together. Also note a sixth embodiment for the top section of a base sheet 681, wherein peg receptacles 682 are used in combination with a container bottom 626, which acts as a peg in securing said container to said base sheet.

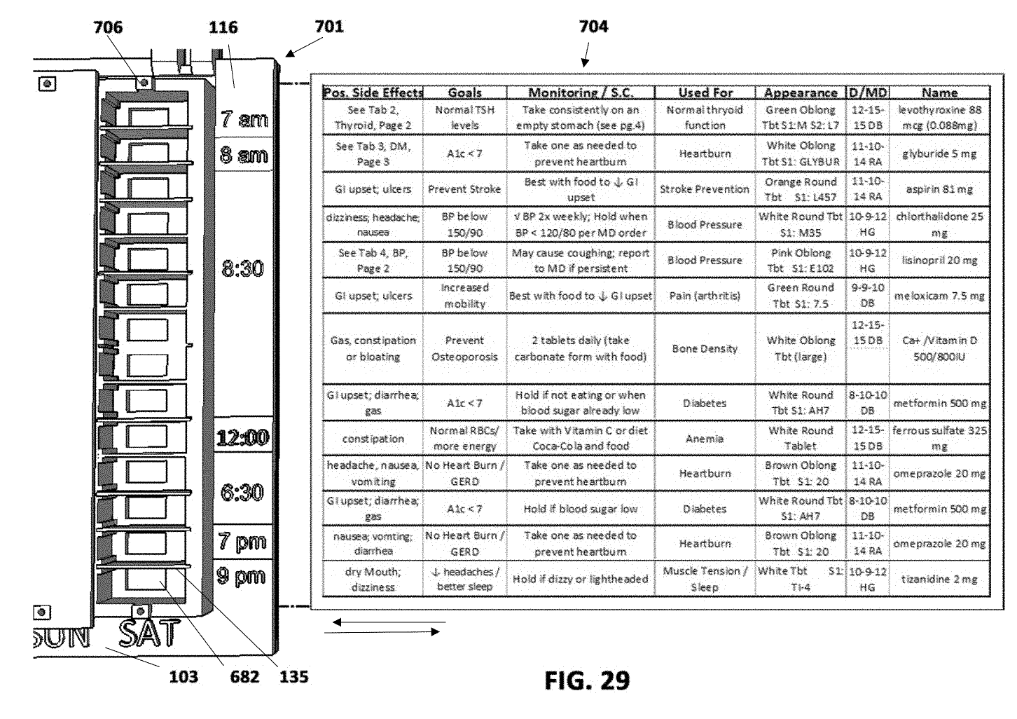

FIG. 29 is a bird's eye view of a seventh embodiment 701 for a base sheet that approximates the second embodiment for a base sheet 201, as shown in FIG. 8. Note labeling space 116 above columns and to the right of rows 356. Also note a letter-sized piece of paper with an example of indicium that could be used when the organizer is used to store medicines. Also note in this embodiment, peg-like protrusions 706 on latitudinal sidewalls that allow securement of non-sliding lids. Said lids fit directly over compartments so that when lifted off vertically, they reveal all compartment or containers within a given row at once. The hole in the center of said peg-like protrusion allows another peg or a screw to be inserted so that the lids may be further secured.

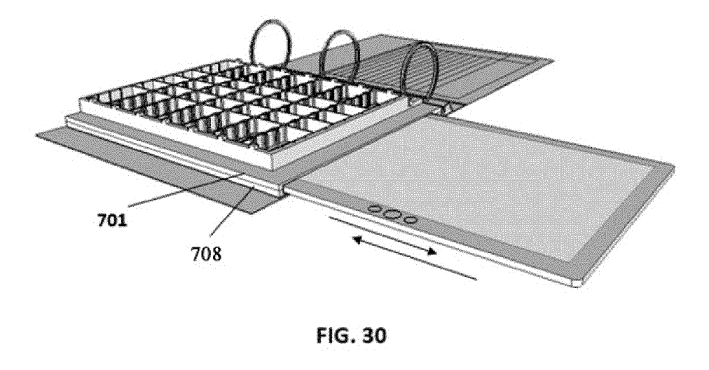

FIG. 30 is a perspective of the previous embodiment for a base sheet, comprising a top 701 and bottom section 708, wherein the indention used for a paper of pull-out component contains a tablet computer. Said tablet computer may display indicia relevant to characterizing stored items. Although not shown graphically, a digital imaging scanner may be inserted into the opening in order to capture an image of stored contents for processing and review, providing the top section of the base sheet is made of a clear material, such as polypropylene or polycarbonate.

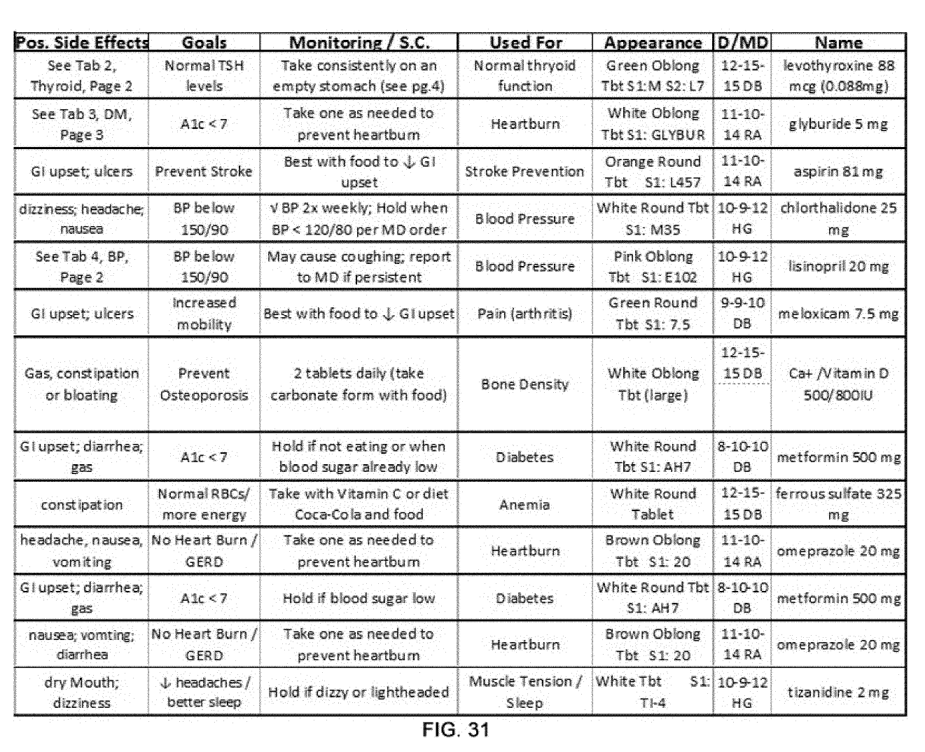

FIG. 31 presents a larger view of a template for a paper or pull-out component, first shown in FIG. 29, which may be used when the organizer is used to store medicines.

FIGS. 10-15 represent an embodiment of a base sheet well suited to exercising all of the capabilities of the organizer. Accordingly, a user first attaches the base sheet to a binder by way of openings that correspond to the rings of a binder. A user has up to 14 compartments per column that they may use to store and organize items, and a total of seven rows, allowing the formation of up to 98 compartments. However, in order to form all of these compartments, removable interior latitudinal sidewalls 336 must be placed into receiving grooves 113 on longitudinal sidewalls, as only six interior latitudinal sidewalls are permanently attached to the base sheet. Thus, without the use of removable interior latitudinal sidewalls, a user has seven compartments per row.

Once a user has stored all the items they wish to store, they may then place a lid 326 over each row by placing it into channels 127 formed along the topside edge of longitudinal sidewalls. Said embodiment comprises the use of a lid retaining component 314 that may be fastened above said channels, thereby preventing the lids from falling if the organizer is turned upside down. Additionally, primary protrusions 324 on said grooves encounter secondary protrusions 330 on flexible arms 328 of the lid as it slides over compartments or removable container on the base sheet. This feature enables the user to adjust the location of a lid in order to expose the contents of a given compartment without the lid moving from that position unless further urged by the user. If the user turns the lid 180 degrees, so that the secondary protrusions are furthest away from the organizer, the resistance is disabled as the secondary protrusions never make contact with the primary protrusions.

A user may also attach a lid closure component 340 to the base sheet, whereby spring operated tension enables the lid to be secured in a closed position as a clasping lip 346 on the component rests in an indention 334 on the top face of the lid 326 when the lid is in a fully closed position. In order to remove the lid from the closed position, a user would press down on the top section of the closure component, as though pressing a button, while simultaneously sliding the lid out from underneath the clasping lip.

A user may also store items in individual containers that fit within compartments, thereby facilitating removal and transport of stored items. These containers comprise a lid and a body that fit within sidewalls. With the third embodiment for a container, shown in FIGS. 26-27, a user may snap the lid into a closed position on the body through urging a hand-like protrusion 644 on the bottom side of the lid into a corresponding opening 650 on the container body. The container may be removed from the organizer through openings on the lid 654 that allow insertion of a tool, such as specialized tweezers 654, as shown in FIG. 28, or a curved pic, a regular pair of tweezers or a paperclip. Thus, when an upward lifting motion is applied, the container may be easily removed from within said sidewalls.

Stored contents may be identified through labeling space, with space for columns 116 above said columns and space for rows 103 to the right of said rows. An opening between the top 301 and bottom 302 sections of the base sheet allows a standard 8.5″×11″ piece of paper or a pull-out component to slide directly beneath stored items. Said paper or pull-out component may contain indicium or labeling to further stratify column contents and provide additional details of stored items. An incline 358 within the opening between the top and bottom section creates friction so as to prevent the paper or pull out component from falling out of the organizer due to gravity. Although not shown graphically, an additional layer of material may be deposited on said incline, such as rubber or silicon, in order to increase friction and resistance to further movement.

Although the organizer may be most helpful in storing and organizing medicines, it may also be helpful in storing and organizing jewelry, seeds for gardening or farming, or paints used by an artist for painting. When storing medicine, the labeling space located to the right of each of the seven rows allows a user to organize their medicine according to each day of the week. Labeling space above columns allow a user to sort medicine according to a specific time of daily administration. They may then use a piece of paper or the pull-out component to further stratify each medicine by name, according to rows, wherein each row on the paper or pull-out component corresponds to a column of medicine stored above. Each row may then be further stratified into columns of information concerning the stored medicine, such as the initials of the prescriber and the date prescribed, the appearance of the medicine, the indication of the medicine or why it was prescribed, the intended result the medicine produces, such as lowering blood pressure, any special considerations or monitoring parameters, and possible side effects.

The size of the smallest compartment in the aforementioned base sheet embodiment is large enough to accommodate the largest tablet or capsule currently available on the market, such as a calcium carbonate tablet or fish oil capsule. If a user were advised to take two of these large tablets or capsules at a particular time of day, they would not need to subdivide a compartment using a removable latitudinal sidewall.

Because the organizer fits within a standard sized notebook, medical information relating to the stored medicines can be readily stored alongside the medicines and sorted through the use of tabs, thereby facilitating retrieval of potentially vital information.

At some point in the future, it's not improbable that instead of a patient picking up a number of different prescription medicines housed in several different prescription bottles from their local pharmacy, and possibly on different days in a given month, they'll be able to pick up all their medicines readily sorted and stored in this organizer, neatly arranged for the proper administration time and containing all the information pertinent to their proper use and even their disease state(s). Furthermore, because several organizers can be stacked upon one another in the same notebook, a patient would be able to pick up one months' worth of medicine at a time.

Alternative embodiments for a base sheet allow for variation with respect to compartment size and number, expandability, type of lid and lid mechanism, extent and location of labeling space, whether related to columns and rows formed on the organizer or on the paper or the pull-out component. Alternative embodiments for containers allow for variation with respect to closing mechanisms, size and method of securement upon a base sheet.

Although not shown graphically, the junction between a base sheet and a lid, or a container body and container lid, may contain a seal or gasket, such as a silicon seal, whereby the contents of a compartment or container may be more thoroughly protected from moisture, air and air-born contaminants.

The embodiments described above may be made of durable materials, such as metal, wood or plastic, with plastic being most likely due to workability, durability, low weight and low cost. Additionally, plastic materials may be transparent, allowing the correlation between stored items and information on the paper or pull-out component to be observed without necessitating their removal from the opening. Formation of the embodiments may occur through injection molding, selective laser sintering, stereolithography, lathing/machining, and/or fused deposition modeling, with injection molding most likely due to its capacity for high volume, low-cost production.

While the present invention has been described with several embodiments, it should be noted that various other embodiments and modifications are possible without departing from the spirit of the invention. Thus, embodiments presented herein are merely illustrative of the features of the invention and should not be construed as the only variants thereof or limited thereto.

I claim:

1. A storage organizer comprising:
a. a base formed from a planar sheet of material, wherein
i. said base contains the means for the attachment and removal of sidewalls and containers, or said base comprises permanently attached sidewalls in combination with the means for the attachment and removal of additional sidewalls and/or containers, whereby a customizable number of compartments is formed upon said base into a series of compartments as a plurality of rows and columns
ii. said containers, when not fitting within said sidewalls, contain the means for attachment and removal from said base for the formation of a plurality of rows and columns
iii. said base contains the means for placement and securement within a loose-leaf ringed binder through corresponding openings near one or more edges of said base, whereby the passage of openable rings attached to said binder may occur through said openings, whereby said organizer can only move along paths delineated by the shape of said rings when closed, whereby said base is confined to said binder
iv. said base comprises space to the right and/or to the left of said rows for the placement of indicium or labeling for identification of contents stored according to rows
v. said base comprises space above and/or below said columns for the placement of indicium or labeling for identification of contents stored according to columns
vi. said base comprises an opening within said base, whether said base is uniform as one piece or comprises a separable top and bottom section, wherein the placement and removal of one or more pieces of paper or a pull-out component may occur.

2. The organizer of claim 1 further comprising a lid made of a transparent material, such as polycarbonate or polypropylene, whereby a user may readily determine the nature of an item stored on said base, or in a container on said base, without having to remove said lid.

3. The organizer of claim 1, wherein said containers may comprise a body, lid, and bottom, wherein said lid contains the means for being securely attached to said body, and wherein said bottom, when present, contains the means for securely attaching to said base sheet.

4. The organizer of claim 1, wherein said containers may comprise a lid with openings, whereby a paperclip, curved pic, or the ends of a standard pair of tweezers or a specialized pair of tweezers may be inserted into said openings, whereby said container may be easily detached or removed from said base sheet when a vertical-lifting force is applied.

5. The organizer of claim 1 comprising a lid, whereby stored contents or containers may be exposed in a rapid manner when said lid is vertically removed from the top wise edge of said sidewalls or pivotally lifted while remaining attached to one sidewall or to the rings of said binder.

6. The organizer of claim 1 comprising a lid for compartments formed between sidewalls, whereby stored contents or containers may be exposed one compartment at a time through a sliding motion of said lid.

7. The organizer of claim 1 comprising a lid according to claim 5, wherein said lid contains a peg receptacle that fits over a peg protruding from the top of a sidewall, or where the entire top side of said sidewall acts as a peg, wherein said peg receptacle on said lid is tapered, whereby an increasingly tighter fit may be produced in accordance with the downward pressure a user applies to the top surface of said lid.

8. The organizer of claim 1 comprising a lid according to claim 5, wherein said lid is used in combination with a peg in the shape of a bolt comprising a tubular bottom section, with or without threads, whereby said bolt-shaped peg may be placed into a hole, with or without receiving threads, in the center of a peg protruding from the top of a sidewall, as described in claim 7, whereby the diameter of the head of said bolt exceeds the diameter of the peg receptacle on said lid, whereby said lid is retained in a closed position.

9. The organizer of claim 1 comprising a lid according to claim 5, wherein said lid contains a flexible seam or living hinge, or a rounded hinge, whereby the other three edges of said lid may become contiguous with the top wise edges of adjacent sidewalls when in a closed position.

10. The organizer of claim 1 comprising a lid according to claim 5, wherein said lid contains a clasp or catch, whereby said lid may snap into a securely closed position, whereby said lid may be retained in a permanently closed position until a releasing force is applied to said clasp or catch by a user.

11. The organizer of claim 1 comprising a lid according to claim 6, wherein said lid may slide along the top-wise edge of two sidewalls, and over any containers stored within said sidewalls, by sliding within a channels on the top-wise edge on said sidewalls, whereby securement of stored items or containers beneath said lid and within said sidewalls may occur.

12. The organizer of claim 1 further comprising a lid retaining component that may be attached to the top of said sidewalls, whereby a lid according to claim 6 may not be removed from said organizer or expose compartments except by a sliding motion.

13. The organizer of claim 1 further comprising a series of primary protrusions on the vertical face of the channels described in claim 11, whereby said primary protrusions come into contact with secondary protrusions on flexible arms of said lid, whereby a predetermined amount of resistance is formed as the secondary protrusion slides past the primary protrusion, whereby said resistance prevents said lid from moving beyond predetermined positions that correspond to the opening of individual compartments, whereby said lid remains in place in spite of gravity or without additional urging by the user, and whereby a tactile sensation corresponds to the proper placement of said lid in accordance to providing access to a given compartment along a series of compartments in a given row of stored items.

14. The organizer of claim 1 further comprising a spring operated lid closure component attached to said base, wherein said component contains a top and bottom section pivotally connected, whereby tension may be formed through the use of said spring situated between said top and bottom sections, whereby a clasping lip on said top section may slide over the top wise face of said lid, coming to rest in an indention on the top face of said lid when in a closed position, whereby said lid cannot be opened unless said top section is depressed by the user and said lid is simultaneously slid out from underneath said clasping lip.

15. The organizer of claim 1, wherein said base sheet may be subdivided and contain the means for subdivided sections to fit together.

16. The organizer of claim 1, wherein longitudinal sidewalls, whether permanent or removable, contain channels, whereby removable latitudinal sidewalls may fit within said channels, whereby a user may increase the number of individual compartments.

17. The organizer of claim 1 comprising removable latitudinal sidewalls in accordance with claim 16, wherein said sidewalls are joined together through a seam running along the top wise edge of said sidewalls, whereby new compartments may be formed within several rows simultaneously, allowing a user to readily facilitate the formation of new compartments.

18. The organizer of claim 1 further comprising a pull-out component, wherein said pull-out contains the means for receiving and displaying digital information, whereby information related to stored contents may be digitally retained, retrieved, modified and reviewed, whereby said pull-out component comprises:
a. a CPU
b. a memory storage system
c. one or more input apparatuses, such as a keyboard, touch-sensitive screen, microphone, universal serial bus port or wireless transmitter
d. one or more output apparatuses, such as a liquid crystal display screen, speaker, universal serial bus port or wireless transmitter.

19. The organizer of claim 1 comprising a pull-out component wherein said pull-out comprises a wipe-able board, whereby a writing utensil containing non-permanent ink may be used for the placement of indicium.

20. The organizer of claim 1 further comprising a means whereby said paper or pull-out component has a reduced likelihood to fall out of the organizer due to gravity as a result of friction created through a rigid or semi-flexible incline situated along the interior of the opening capable of receiving the paper or pull-out component, whereby said paper or pull-out component comes in contact with the surface of said incline as a result of a user urging said paper or pull-out component into said opening.

21. The incline of claim 20 further comprising a layer of material on its surface, such as rubber or silicon, whereby additional frictional resistance may be created so as to prevent said paper or pull-out component from falling out of said organizer due to gravity.

22. The organizer of claim 1 further comprising at least two inclines as described in claim 20, wherein said inclines exist on opposing faces of said opening so as to bend and distorts the normal plane of one or more pieces of paper or a pull-out component as said paper or pull-out component is urged into said opening by a user, or distorts the natural shape of a semi-rigid incline when said pull-component is inflexible, whereby additional friction is created so as to prevent said paper or pull-out component from falling out of said organizer due to gravity.

23. The organizer of claim 1 further comprising a child proofing lock and strap, as would commonly be used on cupboards and cabinets to secure against intrusion by a child, which may be affixed to the outside covers of the binder housing the organizer of claim 1, whereby said organizer may be secured in a closed and tamper-resistant manner.

24. The organizer of claim 1 wherein said organizer comprises three openings capable of receiving the three rings of a loose-leaf three ring binder, wherein said openings are square, whereby more space is available for insertion of said ring when compared to round openings.

25. The organizer of claim 1 wherein said organizer comprises three openings capable of receiving the three rings of a loose-leaf three ring binder, wherein the middle opening is larger than the top and bottom openings, whereby the top and middle opening or bottom and middle opening may be inserted simultaneously into the corresponding rings while the opposite edge is higher than would otherwise be possible with uniformly sized openings, particularly when said insertion occurs in a binder with large rings, such as a 4″ binder.

26. The organizer of claim 1 comprising openings capable of receiving the rings of a binder, wherein said openings are vertically raised above the plane of the bottom face of the organizer commonly in contact with the interior cover of said binder, whereby said organizer may rest completely flat on the interior cover of said binder when said binder is an opened position.

27. A method of familiarizing a user with items stored on the organizer of claim 1, whereby identification and understanding of various characteristics of stored items is facilitated through information stored on the paper or pull-out component that is situated within said opening and beneath stored items, wherein said paper or pull-out component contains indicia arranged into rows that correspond with columns of items stored above, wherein a linear connection is observable between said columns and rows as said paper or pull-out component is slid out from said opening, and when said base and containers are made of a clear material, such as polycarbonate or polypropylene, and wherein further identification and understanding of stored contents may occur through information arranged into columns on said paper or pull-out component.

28. A method of organizing columns and rows of information on the paper or pull-out component claim 1, wherein said paper or pull-out is used to aid in the identification of specific characteristics of stored medicines, wherein each row is organized according to the name of an individual medicine, whereby said rows visibly correspond to columns of medicines stored above on said organizer, and wherein said columns of information on the paper or pull out may comprise the following fields:
a. name of medicine or supplement, strength and prescription number
b. date prescribed and initials of prescribing provider
c. shape, color and/or markings on the tablet or capsule
d. indication of medicine or why it was prescribed
e. the intended result the medicine produces
f. special considerations or monitoring parameters
g. possible side effects

29. A method wherein the organizer of claim 1 is used by a pharmacist in filling prescriptions for a customer, whereby said customer may retrieve all of their medicines and and/or supplements prearranged within said organizer along with a paper or pull-out component completed by the pharmacy according to claim 28, as well as information pertinent to the safe and effective use of said medicines and/or supplements, in accordance with claim 28.

30. A method whereby the organizer of claim 1 is used in conjunction with a device capable of capturing an electronic image, such as a digital imaging scanner, wherein said device slides into said opening, whereby electronic images of stored contents may be captured when the base of claim 1 is made of a clear material, such as polypropylene or polycarbonate, whereby various objects, such as insects, plants, rocks or seeds may be identified and further studied through software used with said scanner or through a tablet computer or similar device connected to said scanner, and wherein an arrangement of said contents may be stored electronically and/or further reviewed according to a pre-programmed arrangement in order to ascertain conformity with an expected arrangement according to the programming of said software.
